(19) United States
(12) Patent Application Publication
(10) Pub. No.: US 2026/0039114 A1
(43) Pub. Date: Feb. 5, 2026

(54) DETECTION OF UNAUTHORIZED ELECTRICAL LOAD ON POWER DISTRIBUTION UNIT (PDU) ASSEMBLY

(71) Applicant: INTERNATIONAL BUSINESS MACHINES CORPORATION, ARMONK, NY (US)

(72) Inventors: Joseph Prisco, Rochester, MN (US); Marc Henri Coq, Hopewell Junction, NY (US); Brian Charles Tucker, Clinton Corners, NY (US); Enver Candan, Cornwall, NY (US)

(21) Appl. No.: 18/791,583

(22) Filed: Aug. 1, 2024

(51) Int. Cl. H02J 3/14; H02J 13/00

(52) U.S. Cl. CPC H02J 3/144; H02J 13/00002; H02J 2203/20

(57) ABSTRACT

Electrical loads from an electrically powered unit plugged into a receptacle of a power distribution unit (PDU) can be detected, using a computer communicating with the PDU. The electrical load is analyzed by comparing an electrical cycle waveform of the electrical load to electrical cycle waveforms of problem waveforms accessible by the computer. When the electrical cycle waveform of the electrical load matches an electrical cycle waveform of one of the problem waveforms. In response to the electrical cycle waveform of the electrical load matching the electrical cycle waveform of one of the problem waveforms, the computer initiates an action to disable electrical power to the receptacle of the PDU.

### BACKGROUND

The present disclosure relates to detection of electrical loads on a power distribution unit assembly.

In one example, increased demand for cloud computing has accelerated the construction of datacenters with high power capacity and resiliency. These datacenters can be associated with cloud service providers responding to edge computing and datacenter demands using rack mount servers and/or other electrical devices in the racks, or for example, electrical cabinets or frames. In some situations, personnel (e.g., operator, service person, or administrator) in a datacenter may use one or more AC (alternating current) outlets that are available or nearby to plug in equipment.

In one example, if a person plugs equipment into a port or outlet (or receptacle) on a PDU (power distribution unit) assembly which can be on a rack, e.g., a rack PDU, and herein referred to as a rack PDU, the electrical signal can cause disturbance to subassemblies within the rack drawing power from the rack PDU or from outer power sources. This can trigger abnormal behaviors on certain components, and/or a power outage.

### SUMMARY

The present disclosure recognizes the shortcomings and problems associated with current techniques for detecting electrical loads on a power distribution unit.

The present invention provides a solution for detecting an unauthorized electrical load on a power distribution unit.

In one example, the present invention provides the capability to detect non-authorized or unauthorized signals from a plugged-in electrical device to a port or outlet or receptacle on a rack PDU which can be part of or electrically connected to electrical components (e.g., rackmount servers) on a rack. The invention can thereby take one or more actions to prevent possible catastrophic cascading events down-stream from the port to electrical components on the racks, such as the rack mount servers and/or other electrical devices.

In an aspect according to the present invention, a computer implemented method for detecting electrical loads on a power distribution unit (PDU) assembly includes detecting, using a computer communicating with a PDU, an electrical load received at a receptacle of the PDU when a connector of an electrically powered unit producing the electrical load is plugged into a receptacle of the PDU. The method includes analyzing, using the computer, the electrical load by comparing an electrical cycle waveform of the electrical load to electrical cycle waveforms of problem waveforms accessible by the computer. The method includes determining, based on the analyzing of the electrical load and using the computer, when the electrical cycle waveform of the electrical load matches an electrical cycle waveform of one of the problem waveforms. The method includes, in response to the electrical cycle waveform of the electrical load matching the electrical cycle waveform of one of the problem waveforms, the computer initiating an action to disable electrical power to the receptacle of the PDU.

In a related aspect, the action includes triggering an alarm.

In a related aspect, the alarm includes a message explaining the action and a reason for the action.

In a related aspect, the action includes disabling electrical power to the PDU by opening an electrical circuit which provides electrical power to the PDU.

In a related aspect, the disabling of the electrical power includes disconnecting electrical continuity to the PDU.

In a related aspect, the disabling of the electrical power includes opening an electrical switch upstream of the electrical load for the receptacle of the PDU in an electrical power circuit.

In a related aspect, the method further includes identifying, using the computer communicating with the PDU, the electrical cycle waveforms which are the problem waveforms, and the electrical cycle waveforms being received at the receptacle of the PDU.

In a related aspect, the method further includes detecting, using the computer, a step change in the electrical load and ignoring a first group of cycles of starting current. The method further includes analyzing, using the computer, a next group of cycles of the starting current and comparing it to disturbing parameters to categorize a type of the electrical load including as a problem electrical load when the electrical load has one of the problem waveforms.

In a related aspect, the computer can be part of the PDU.

In a related aspect, the PDU can be part of a computer data center.

In a related aspect, the PDU can be part of a rack in a computer data center.

In a related aspect, the method can further include determining when the electrically powered unit producing the electrical load is not connected to the receptacle of the PDU, in response to the initiating of the action to disable electrical power to the receptacle of the PDU. And, the method can include restoring electrical power to the receptacle of the PDU when the electrically powered unit producing the electrical load is not connected to the receptacle of the PDU.

In another embodiment according to the present invention, a system for detecting electrical loads on a power distribution unit (PDU) includes a computer system comprising a computer processor, a computer-readable storage medium, and program instructions stored on the computer-readable storage medium. The program instruction being executable by the processor, to cause the computer system to perform the following functions. A function to detect, using a computer communicating with a PDU, an electrical load received at a receptacle of the PDU when a connector of an electrically powered unit producing the electrical load is plugged into the receptacle of the PDU. A function to analyze, using the computer, the electrical load by comparing an electrical cycle waveform of the electrical load to electrical cycle waveforms of problem waveforms accessible by the computer. A function to determine, based on the analysis and using the computer, when the electrical cycle waveform of the electrical load matches an electrical cycle waveform of one of the problem waveforms. And a function to, in response to the electrical cycle waveform of the electrical load matching the electrical cycle waveform of one of the problem waveforms, initiate, using the computer, an action to disable electrical power to the receptacle of the PDU.

In a related aspect, the action can include triggering an alarm.

In a related aspect, the alarm can include a message explaining the action and a reason for the action.

In a related aspect, the action can include disabling electrical power to the receptacle of the PDU by opening an electrical circuit which provides electrical power to the receptacle of the PDU.

In a related aspect, the disabling of the electrical power includes disconnecting electrical continuity to the receptacle of the PDU.

In a related aspect, the disabling of the electrical power includes opening an electrical switch upstream of the electrical load for the receptacle of the PDU in an electrical power circuit.

In a related aspect, the system further includes functions to identify, using the computer communicating with the PDU, the electrical cycle waveforms which are the problem waveforms, and the electrical cycle waveforms being received at the receptacle of the PDU.

In another embodiment according to the present invention, a computer program product for detecting electrical loads on a power distribution unit (PDU) assembly comprises a computer readable storage medium having program instructions embodied therewith. The program instructions are executable by a computer to cause the computer to perform functions, by the computer, comprising the following functions. A function to detect, using a computer communicating with a PDU, an electrical load received at a receptacle of the PDU when a connector of an electrically powered unit producing the electrical load is plugged into the receptacle of the PDU. A function to analyze, using the computer, the electrical load by comparing an electrical cycle waveform of the electrical load to electrical cycle waveforms of problem waveforms accessible by the computer. A function to determine, based on the analysis and using the computer, when the electrical cycle waveform of the electrical load matches an electrical cycle waveform of one of the problem waveforms. A function to, in response to the electrical cycle waveform of the electrical load matching the electrical cycle waveform of one of the problem waveforms, initiate, using the computer, an action to disable electrical power to the receptacle of the PDU.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a flow chart of a process, according to an embodiment of the present disclosure, for detecting electrical loads on a power distribution unit.

FIG. 2 is a flow chart of a process, according to an embodiment of the present disclosure, for reconnecting a PDU after opening a relay in response to detecting an electrical load on a power distribution unit.

FIG. 3 is a schematic diagram illustrating a system according to an embodiment of the present disclosure, for detecting electrical loads on a power distribution unit which uses a relay to disable a power distribution unit.

FIG. 4 is a schematic block diagram illustrating a system according to an embodiment of the present disclosure, for detecting electrical loads on a power distribution unit.

FIG. 5 is a flow chart of a method, according to an embodiment of the present disclosure, which can use the system depicted in FIG. 4, for detecting electrical loads on a power distribution unit.

FIG. 6 is a schematic block diagram depicting a computer system according to an embodiment of the disclosure, which includes cloud computing components and functions, and which can cooperate with the systems and methods shown in the figures and described herein.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component” includes reference to one or more of such components unless the context clearly dictates otherwise. It is also understood that reference to a port, or an outlet, or a receptacle, of a PDU or rack PDU are referring to the same element of a PDU, as such descriptions as port, outlet, or receptacle are used in the art to refer to the same element.

### EMBODIMENTS AND EXAMPLES

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method. It is understood that a user can be a customer, an individual, or a group of individuals, or a company or an organization.

In one example, unauthorized loads can disturb (e.g., PLD (Power Line Disturbance), or EMI (electromagnetic interference)) or disrupt (e.g., overheat, or overcurrent) the operation of one or more receptacle of a rack PDU or the loads connected to the rack PDU. Examples of unauthorized loads which can be connected to rack PDUs in data centers can include vacuums (e.g., traditional, or a shop vacuum). Such a device can cause harmonic distortion such as displacement (phase shift) and waveform distortion. Harmonics currents can lead to voltage distortion. Voltage distortion can impact power quality. High amperage loads for short durations can cause steady-steady amperage which can trip a circuit breaker. In one example, based on i²t (Ampere Squared Seconds, which is the thermal energy to melt, arc or clear a specific current, or melting point in a fuse) curves and ambient temperature, for example, a circuit breaker (CB) can be overloaded from seconds to hours.

Other tools, equipment, and appliances can include stepper motors, commutation motors, etc. Such tools can have many starts/stops with fast current rise times that can impact conducted immunity. In another example, printers/copiers can have multi-cycle symmetrical control, etc., with high harmonic currents, and heating element control on half-cycle basis. In another example, lighting can be plugged into the rack PDU receptacle. In one example, a rack PDU can have a multiplicity of receptacles. In another example, room power distribution units may be present in a data center and may not have receptacles to plug-in equipment. A rack PDU communicates with a rack, cabinet or frame and may have a multiplicity of receptacles.

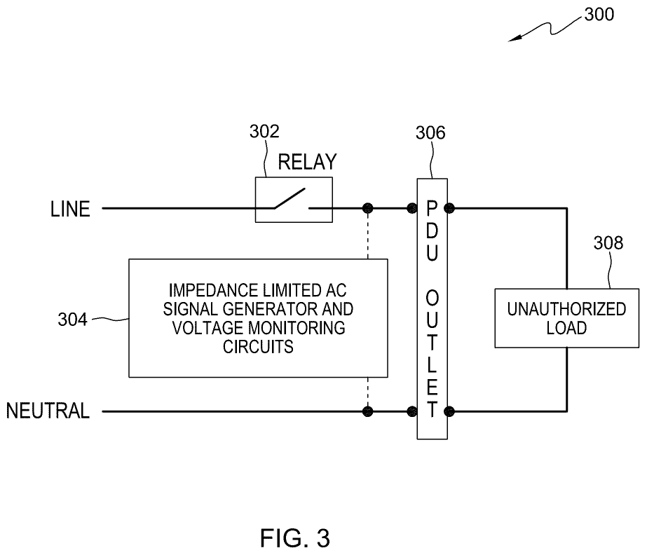

In one or more examples unauthorized loads on an electrical circuit or a rack PDU can be detected in various ways including waveform comparison, harmonics (set thresholds for distortion percentage and displacement phase angle), and detection of high frequency noise, transients, or ripple. In response to detecting an unauthorized load 308 (FIG. 3), a rejection of an unauthorized load can include posting a warning and/or opening a relay that opens an electrical circuit to stop electric current/power to a rack receptacle and an electrical device initiating the unauthorized load.

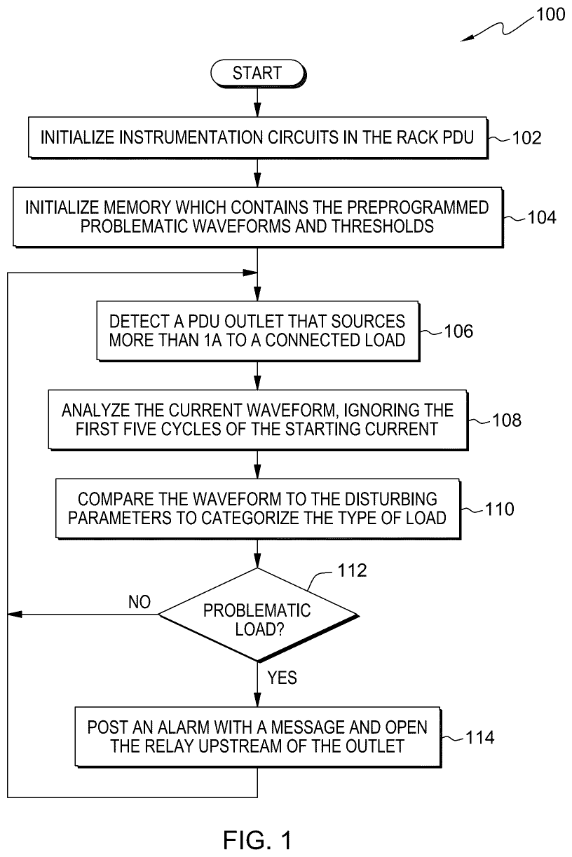

Referring to FIGS. 1 and 3, in one embodiment according to the present disclosure, a method 100 includes initializing instrumentation circuits in a rack PDU, as in operation 102. A rack PDU having a processor or computer, can be preprogramed with problematic waveforms, maximum Vthd (Voltage total harmonic distortion, maximum cos Φ (maximum phase shift between voltage and current waveforms) both of which can be stored in memory in the rack PDU, as in operation 104.

When a load is plugged into a rack PDU receptacle, the method includes detecting a rack PDU outlet or receptacle that sources more than 1 A (AMP) to a connected load, as in operation 106. Inrush current and non-operating current below 1 Å (Amp) (˜200 VA (Volt Amps)) can be ignored. The low VA can be non-disturbing loads due to the contribution on a circuit capable of 15 Å-20 Å, and can include PSU control supplies.

The rack PDU can detect a step change in the load (e.g., switching from off to on) and can ignore the first five cycles of starting current. The rack PDU processor can analyze the next five cycles and compare it to the disturbing parameters to categorize the type of load and if it's problematic, as in operation 108. The method includes comparing the waveform to disturbing parameters of problematic waveforms to categorize the type of load, as in operation 110.

At operation 112, if the waveform is not a problematic load, the method returns to operation 106. If the waveform is a problematic load, the method proceeds to operation 114.

If the load is problematic, the processor can signal the relay upstream of the receptacle to open 302, thus opening the electrical circuit and cutting power downstream, as in operation 114. The rack PDU can also post an alarm with a message explaining the action it took and the reason why it took the action, as in operation 114.

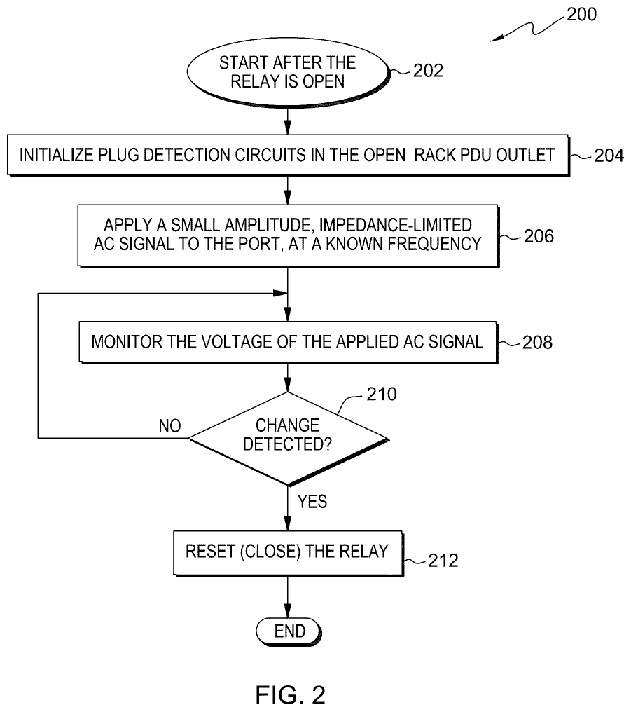

Referring to FIGS. 2 and 3, in one embodiment according to the present disclosure, a process or method 200 to reset (or close) a relay after opening the relay (e.g., open relay 302), in an electrical circuit 300, as in operation 202, as described above regarding the method 100 shown in FIG. 1. The method 200 can include in one option, manually, after a visual inspection confirms that nothing is plugged into the rack PDU receptacle, closing the relay, or automatically, after the rack PDU self-determines that nothing is plugged into the receptacle, automatically closing the relay.

The method 200 includes the rack PDU initializing plug detection circuits at an outlet with the unauthorized load 308 after its relay is open, as in operation 204. The method 200 includes applying an impedance-limited AC signal, using an impedance limited AC signal generator and voltage monitoring circuits 304 (FIG. 3), to the rack PDU outlet 306 at a known open-circuit operating voltage magnitude and frequency, as in operation 206. The method includes the instrumentation circuits at the outlet detecting a change in the voltage of the applied AC signal, due to the impedance-limited nature of the source, when the unauthorized load 308 is unplugged, as in operation 208. In operation 210, if a change is not detected, the method returns to operation 208. If a change is detected, the method proceeds to operation 212. In response to the detecting that the unauthorized load is unplugged, the rack PDU resets (or closes) the relay, as in operation 212.

Thereby, embodiments of the present disclosure compare waveforms for categorization and determination of being problematic, and also determines if a load should remain connected to the rack PDU receptacle or should be disconnected. In another example, embodiments of the present disclosure can monitor AC (Alternating Current) waveforms going through a power distribution unit outlet to determine if a connected load is in the list of a predetermined problematic loads. In another example, embodiments of the present disclosure can include comparing energy related waveforms to categorizations and determinations of problematic waveforms in a data center environment. In response to determining that a waveform is one of the problematic waveforms, a load can be disconnected from a rack PDU receptacle, and if the waveform is not problematic, the load or the power consuming unit or device generating the load can remain connected to the power distribution unit.

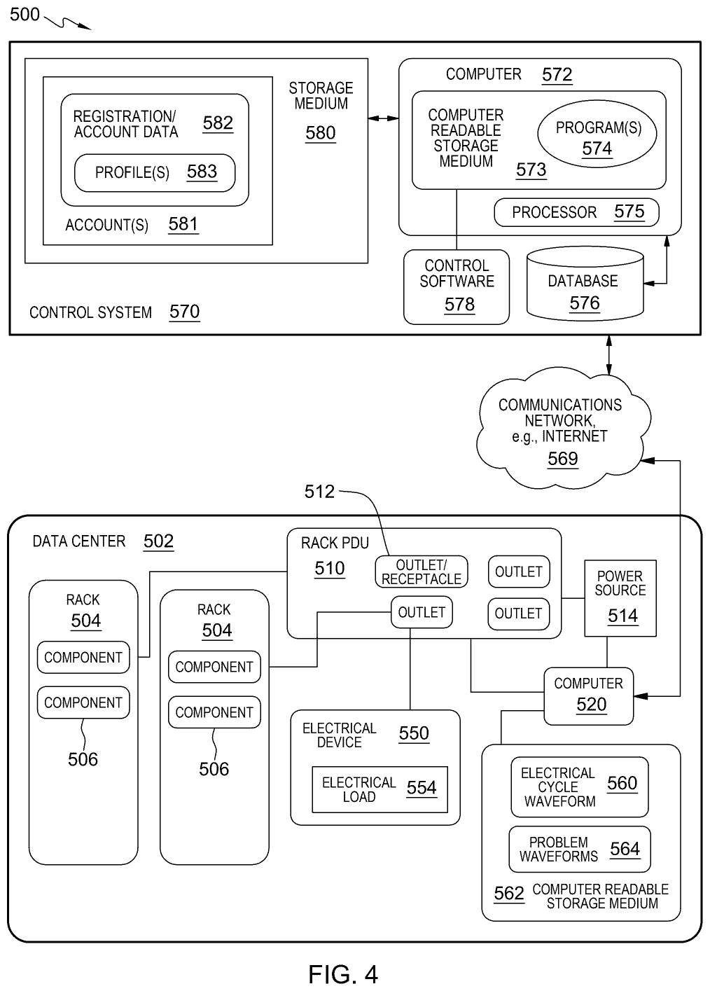

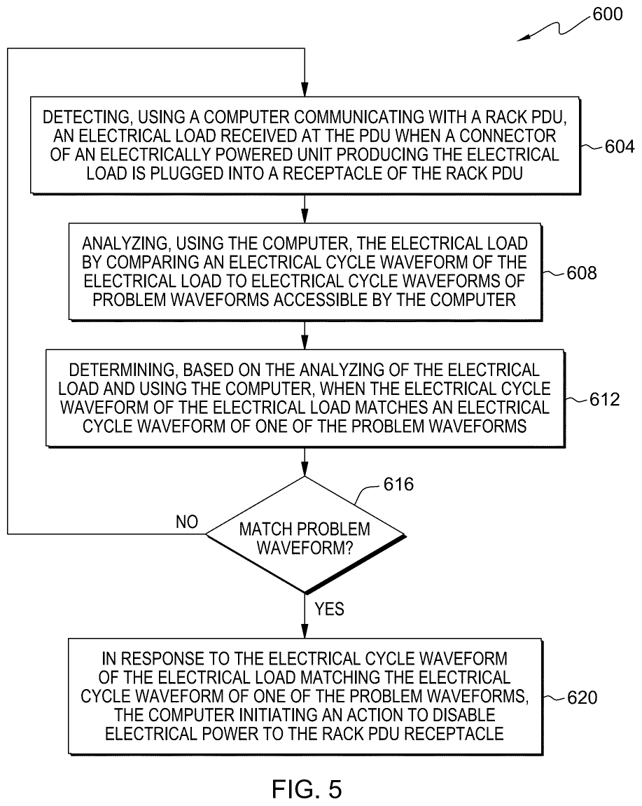

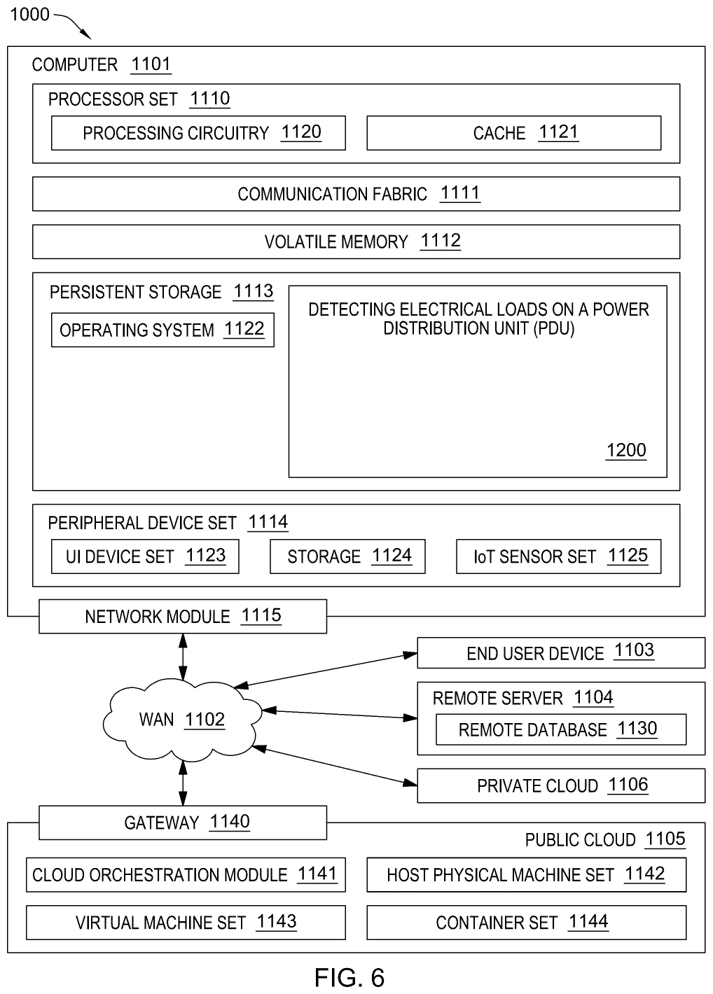

Referring to FIGS. 4 and 5, according to an embodiment of the present disclosure, a system 500 (shown in FIG. 5) is used for detecting electrical loads on a power distribution unit. A method 600 (shown in FIG. 6) for detecting electrical loads on a power distribution unit (PDU), can use the system 500 to implement the functions and operations described herein. The method 600 includes detecting, using a computer 520 communicating with a rack PDU 510, an electrical load 554 received at the rack PDU when a connector of an electrically powered unit such as an electrical device 550 producing the electrical load 554 is plugged into a receptacle or outlet 512 of the rack PDU 510, as in operation 604.

The method 600 includes analyzing, using the computer 520, the electrical load 554 by comparing an electrical cycle waveform 560 of the electrical load to electrical cycle waveforms of problem waveforms 564. The electrical cycle waveform 560 and the problem waveforms 564 can be stored on a computer readable medium 562 accessible to the computer 520, as in operation 608.

The method 600 includes determining, based on the analyzing of the electrical load and using the computer, when the electrical cycle waveform of the electrical load matches an electrical cycle waveform of one of the problem waveforms, as in operation 612.

In operation 616, when the method determines an electrical cycle waveform of the electrical load does not match an electrical cycle waveform of one of the problem waveforms, the method returns to operation 604. When the method determines an electrical cycle waveform of the electrical load matches an electrical cycle waveform of one of the problem waveforms, the method proceeds to operation 620.

The method 600 includes, in response to the electrical cycle waveform of the electrical load matching the electrical cycle waveform of one of the problem waveforms, the computer initiating an action, as in operation 620. In one example the action can include disabling electrical power to the receptacle of the rack PDU (or in other words, the rack PDU receptacle).

In one example, the action can include triggering an alarm. For example, an action can be an alarm which can include an audible alarm, or a message sent to a device to alert a user of a match of the electrical cycle waveform to one of the problem waveforms, and/or alert a user of disablement of power to the rack PDU receptacle.

In one example, the alarm can include a message explaining the action and a reason for the action.

In another example, the action can include disabling electrical power to the rack PDU receptacle by opening an electrical circuit which provides electrical power to the rack PDU receptacle.

In another example, the disabling of the electrical power can include disconnecting electrical continuity to the rack PDU receptacle.

In another example, the disabling of the electrical power can include opening an electrical switch (for example, a relay) upstream of the electrical load for the rack PDU receptacle in an electrical power circuit, thereby disabling electrical power to the rack PDU receptacle.

In another example, the method further includes identifying, using the computer communicating with the rack PDU, the electrical cycle waveforms which are the problem waveforms, and the electrical cycle waveforms received at the rack PDU receptacle.

In another example, the method can further include detecting, using the computer, a step change in the electrical load and ignoring a first group of cycles of starting current. The method includes analyzing, using the computer, a next group of cycles of the starting current and comparing it to disturbing parameters to categorize a type of the electrical load including as a problem electrical load when the electrical load has one of the problem waveforms.

In another example, the computer can be part of the rack PDU. The rack PDU can be electrically communicating with a power source 514. In another example, the rack PDU can be part of a computer data center 502 providing power to components 506 in one or more racks 504. In another example, the rack PDU can be part of or communicating with a rack 504 in a computer data center 502.

In another example, the method can further include determining when the electrically powered unit producing the electrical load is not connected to the rack PDU receptacle, in response to the initiating of the action to disable electrical power to the rack PDU receptacle. And, the method can include restoring electrical power to the rack PDU receptacle when the electrically powered unit producing the electrical load is not connected to the rack PDU receptacle.

In another embodiment according to the present disclosure, a system for detecting electrical loads on a power distribution unit (PDU) can include a computer system comprising a computer processor, a computer-readable storage medium, and program instructions stored on the computer-readable storage medium. The program instructions are executable by the processor to cause the computer system to perform the following functions. One function is to detect, using a computer communicating with a rack PDU, an electrical load received at the rack PDU when a connector of an electrically powered unit producing the electrical load is plugged into a receptacle of the rack PDU. Another function is to analyze, using the computer, the electrical load by comparing an electrical cycle waveform of the electrical load to electrical cycle waveforms of problem waveforms accessible by the computer. Another function is to determine, based on the analysis and using the computer, when the electrical cycle waveform of the electrical load matches an electrical cycle waveform of one of the problem waveforms. And another function is to, in response to the electrical cycle waveform of the electrical load matching the electrical cycle waveform of one of the problem waveforms, initiate, using the computer, an action which can include the function to disable electrical power to the rack PDU receptacle.

In another embodiment according to the present disclosure, a computer program product to improve performance of a computer simulation using sampling can include a computer readable storage medium having program instructions embodied therewith. The program instructions are executable by a computer to cause the computer to perform functions, by the computer, comprising the following functions. The functions include a function to detect, using a computer communicating with a rack PDU, an electrical load received at the rack PDU when a connector of an electrically powered unit producing the electrical load is plugged into a receptacle of the rack PDU. The functions include a function to analyze, using the computer, the electrical load by comparing an electrical cycle waveform of the electrical load to electrical cycle waveforms of problem waveforms accessible by the computer. The functions include a function to determine, based on the analysis and using the computer, when the electrical cycle waveform of the electrical load matches an electrical cycle waveform of one of the problem waveforms. And the functions include a function to, in response to the electrical cycle waveform of the electrical load matching the electrical cycle waveform of one of the problem waveforms, initiate, using the computer, an action which can include a function to disable electrical power to the rack PDU receptacle.

### OTHER EXAMPLES AND EMBODIMENTS

In another embodiment according to the present disclosure, a PDU assembly for detecting electrical loads on the power distribution unit (PDU) assembly includes a computer communicable with the PDU, such as a rack PDU. The computer is configured to detect an electrical load received at a receptacle of the PDU when a connector of an electrically powered unit producing the electrical load is plugged into the receptacle of the PDU. The computer is configured to analyze the electrical load by comparing an electrical cycle waveform of the electrical load to electrical cycle waveforms of problem waveforms accessible by the computer, for example stored on a computer readable medium. Based on the analysis of the electrical load using the computer, the computer can determine when the electrical cycle waveform of the electrical load matches an electrical cycle waveform of one of the problem waveforms. In response to the electrical cycle waveform of the electrical load matching the electrical cycle waveform of one of the problem waveforms, the computer configured to initiate an action to disable electrical power to the receptacle of the PDU.

In one example, the computer 520 can include a processor and a computer readable storage medium where an application can be stored which can in one example, embody all or part of the method(s) of the present disclosure. The application can include all or part of instructions to implement the method of the present disclosure, embodied in code and stored on a computer readable storage medium. The computer and/or device can include a display. The computer 520 can operate, in all or in part, in conjunction with a remote server by way of a communications network 569, for example, the Internet.

In other embodiments and examples, in the present disclosure shown in the figures, a computer can be part of a remote computer or a remote server, for example, a remote server. In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs. A device(s), for example a mobile device or mobile phone, can belong to one or more users, and can be in communication with the control system via the communications network.

### ADDITIONAL EXAMPLES AND EMBODIMENTS

Referring to the figures, and for example, FIG. 4, the system 500 includes a computer 572 which can be integral to or communicating with a device and communicate with other computers such as computer 520 in the data center 502. The control system 570 can include the computer 572 having a computer readable storage medium 573 which can store one or more programs 574, and a processor 575 for executing program instructions. The control system 570 can include control software 578 for managing the one or more programs. The control system can also include a storage medium which can include registration and/or account data 582 and user profiles 583 of users or entities (such entities can include robotic entities) as part of user accounts 581. User accounts 581 can be stored on a storage medium 580 which is part of the control system 570. The user accounts 581 can include registrations and account data 582 and user profiles 583. The control system can also include the computer 572 having a computer readable storage medium 573 which can store programs or code embedded on the storage medium. The program code can be executed by a processor 575. The computer 572 can communicate with a database 576. The control system 570 can also include a database 576 for storing all or part of such data as described above, and other data.

In another example and embodiment, profiles can be saved for entities such as users, participants, operators, human operators, or robotic devices. Such profiles can supply data regarding the user and history of deliveries for analysis. In one example, a user can register or create an account using the control system which can include one or more profiles as part of registration and/or account data. A user and an account can refer to, for example, a person, an administrator, or an operator, or an entity, or a corporate entity, or a corporate department, or another machine such as an entity for automation such as a system using, in all or in part, artificial intelligence.

### STILL FURTHER EMBODIMENTS AND EXAMPLES

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

### MORE EXAMPLES AND EMBODIMENTS

Additionally, methods and systems according to embodiments of the present disclosure can be discussed in relation to a functional system(s) depicted by functional block diagrams. The methods and systems can include components and operations for embodiments according to the present disclosure, and is used herein for reference when describing the operational steps of the methods and systems of the present disclosure. Additionally, the functional system, according to an embodiment of the present disclosure, depicts functional operations indicative of the embodiments discussed herein.

The methods and systems of the present disclosure can include a series of operational blocks for implementing one or more embodiments according to the present disclosure. A method shown in the figures may be another example embodiment, which can include aspects/operations shown in another figure and discussed previously but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is also understood that the one or more computers or computer systems shown in the figures can include all or part of a computing environment and its components shown in another figure, for example, the computing environment 1000 can be incorporated, in all or in part, in one or more computers or devices shown in other figures and described herein. In one example, the one or more computers can communicate with all or part of a computing environment and its components as a remote computer system to achieve computer functions described in the present disclosure.

### MORE ADDITIONAL EXAMPLES AND EMBODIMENTS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 6, a computing environment 1000 contains an example of an environment for the execution of at least some of the computer code involved in performing the inventive methods, such as using a computer for detecting electrical loads on a power distribution unit 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

What is claimed is:

1. A computer implemented method for detecting electrical loads on a power distribution unit (PDU) assembly, comprising:
detecting, using a computer communicating with a PDU, an electrical load received at a receptacle of the PDU when a connector of an electrically powered unit producing the electrical load is plugged into the receptacle of the PDU;
analyzing, using the computer, the electrical load by comparing an electrical cycle waveform of the electrical load to electrical cycle waveforms of problem waveforms accessible by the computer;
determining, based on the analyzing of the electrical load and using the computer, when the electrical cycle waveform of the electrical load matches an electrical cycle waveform of one of the problem waveforms; and
in response to the electrical cycle waveform of the electrical load matching the electrical cycle waveform of one of the problem waveforms, the computer initiating an action to disable electrical power to the receptacle of the PDU.

2. The method of claim 1, wherein the action includes triggering an alarm.

3. The method of claim 2, wherein the alarm includes a message explaining the action and a reason for the action.

4. The method of claim 1, wherein the action includes disabling electrical power to the receptacle of the PDU by opening an electrical circuit which provides electrical power to the receptacle of the PDU.

5. The method of claim 1, wherein the disabling of the electrical power includes disconnecting electrical continuity to the receptacle of the PDU.

6. The method of claim 5, wherein the disabling of the electrical power includes opening an electrical switch upstream of the electrical load for the receptacle of the PDU in an electrical power circuit.

7. The method of claim 1, further comprising:
identifying, using the computer communicating with the PDU, the electrical cycle waveforms which are the problem waveforms, and the electrical cycle waveforms being received at the receptacle of the PDU.

8. The method of claim 1, further comprising:
detecting, using the computer, a step change in the electrical load and ignoring a first group of cycles of starting current; and
analyzing, using the computer, a next group of cycles of the starting current and comparing it to disturbing parameters to categorize a type of the electrical load including as a problem electrical load when the electrical load has one of the problem waveforms.

9. The method of claim 1, wherein the computer is part of the PDU.

10. The method of claim 1, wherein the PDU is part of a computer data center.

11. The method of claim 1, wherein the PDU is part of a rack in a computer data center.

12. The method of claim 1, further comprising:
determining when the electrically powered unit producing the electrical load is not connected to the receptacle of the PDU, in response to the initiating of the action to disable electrical power to the PDU; and
restoring electrical power to the receptacle of the PDU when the electrically powered unit producing the electrical load is not connected to the receptacle of the PDU.

13. A system for detecting electrical loads on a power distribution unit (PDU) assembly, which comprises:
a computer system comprising; a computer processor, a computer-readable storage medium, and program instructions stored on the computer-readable storage medium being executable by the processor, to cause the computer system to perform the following functions to;
detect, using a computer communicating with a PDU, an electrical load received at a receptacle of the PDU when a connector of an electrically powered unit producing the electrical load is plugged into the receptacle of the PDU;
analyze, using the computer, the electrical load by comparing an electrical cycle waveform of the electrical load to electrical cycle waveforms of problem waveforms accessible by the computer;
determine, based on the analysis and using the computer, when the electrical cycle waveform of the electrical load matches an electrical cycle waveform of one of the problem waveforms; and
in response to the electrical cycle waveform of the electrical load matching the electrical cycle waveform of one of the problem waveforms, initiate, using the computer, an action to disable electrical power to the receptacle of the PDU.

14. The system of claim 13, wherein the action includes triggering an alarm.

15. The system of claim 14, wherein the alarm includes a message explaining the action and a reason for the action.

16. The system of claim 13, wherein the action includes disabling electrical power to the receptacle of the PDU by opening an electrical circuit which provides electrical power to the receptacle of the PDU.

17. The system of claim 13, wherein the disabling of the electrical power includes disconnecting electrical continuity to the receptacle of the PDU.

18. The system of claim 17, wherein the disabling of the electrical power includes opening an electrical switch upstream of the electrical load for the receptacle of the PDU in an electrical power circuit.

19. The system of claim 13, further comprising functions to:
identify, using the computer communicating with the PDU, the electrical cycle waveforms which are the problem waveforms, and the electrical cycle waveforms being received at the receptacle of the PDU.

20. A computer program product for detecting electrical loads on a power distribution unit (PDU) assembly, the computer program product comprising a computer readable storage medium having program instructions embodied therewith, the program instructions executable by a computer to cause the computer to perform functions, by the computer, comprising the functions to:
detect, using a computer communicating with a PDU, an electrical load received at a receptacle of the PDU when a connector of an electrically powered unit producing the electrical load is plugged into a receptacle of the PDU;
analyze, using the computer, the electrical load by comparing an electrical cycle waveform of the electrical load to electrical cycle waveforms of problem waveforms accessible by the computer,
determine, based on the analysis and using the computer, when the electrical cycle waveform of the electrical load matches an electrical cycle waveform of one of the problem waveforms; and
in response to the electrical cycle waveform of the electrical load matching the electrical cycle waveform of one of the problem waveforms, initiate, using the computer, an action to disable electrical power to the receptacle of the PDU.
